(19) United States
(12) Patent Application Publication
(10) Pub. No.: US 2019/0354533 A1
(43) Pub. Date: Nov. 21, 2019

(54) INFORMATION PROCESSING DEVICE, INFORMATION PROCESSING METHOD, AND NON-TRANSITORY COMPUTER-READABLE RECORDING MEDIUM

(71) Applicant: YAHOO JAPAN CORPORATION, Tokyo (JP)

(72) Inventors: Tasuku MIYAZAKI, Tokyo (JP); Hayato KOBAYASHI, Tokyo (JP); Kohei SUGAWARA, Tokyo (JP); Masaki NOGUCHI, Tokyo (JP); Tomoya YAMAZAKI, Tokyo (JP); Kazuki YAMAUCHI, Tokyo (JP)

(73) Assignee: YAHOO JAPAN CORPORATION, Tokyo (JP)

(21) Appl. No.: 16/284,383

(22) Filed: Feb. 25, 2019

(30) Foreign Application Priority Data
May 18, 2018 (JP) 2018-096576

(51) Int. Cl. G06F 16/2457; G06F 16/901; G06F 16/951

(52) U.S. Cl. CPC G06F 16/24578; G06F 16/951; G06F 16/9024

(57) ABSTRACT

An information processing device according to the application concerned includes a generating unit and a providing unit. The generating unit generates a rating function for each node of a second-type graph which is generated from a first-type graph in which predetermined elements are treated as nodes and the relationships among the elements are treated as links, and which indicates a futuristic state of the first-type graph. The providing unit provides the information related to the second-type graph based on the rating function for the each node as generated by the generating unit.

### CROSS-REFERENCE TO RELATED APPLICATION(S)

The present application claims priority to and incorporates by reference the entire contents of Japanese Patent Application No. 2018-096576 filed in Japan on May 18, 2018.

### BACKGROUND OF THE INVENTION

### 1. Field of the Invention

The present invention relates to an information processing device, an information processing method, and a non-transitory computer-readable recording medium.

### 2. Description of the Related Art

Conventionally, a technology is known that calculates the rating of a variety of information and provides the calculated rating. As an example of such a technology, a technology is known in which the degree of importance of each sentence is calculated by implementing the PageRank algorithm transformed into a graph.

[Patent Literature 1] Japanese Patent Application Laid-open No. 2017-54509

[Non-patent Literature 1] “Dynamic PageRank Using Evolving Teleportation”, Ryan A. Rossi and David F. Gleich <Internet>http://ryanrossi.com/pubs/rossi-gleich-dynamic-pagerank.pdf (searched on May 7, 2018)

[Non-patent Literature 2] “A Dynamical System for PageRank with Time-Dependent Teleportation”, David F. Gleich and Ryan A. Rossi Internet Mathematics Vol. 10: 188-217 <Internet>http://ryanrossi.com/pubs/dynamic-pagerank.pdf (searched on May 7, 2018)

However, there are times when it is not possible to appropriately provide the information that is based on the rating obtained by taking into account the future. For example, if only the rating of the targets such as documents is obtained, then that rating is meant for the present time and cannot be said to be the rating that takes into account the progress in future, that is, cannot be said to be a futuristic rating. Hence, there are times when it is not possible to appropriately provide the information that is based on the rating obtained by taking into account the future.

### SUMMARY OF THE INVENTION

It is an object of the present invention to at least partially solve the problems in the conventional technology.

According to one aspect of an embodiment, an information processing apparatus includes a generating unit that generates a rating function for each node of a second-type graph which is generated from a first-type graph in which predetermined elements are treated as nodes and relationships among the elements are treated as links, and which indicates a futuristic state of the first-type graph; and a providing unit that provides information related to the second-type graph based on the rating function for the each node as generated by the generating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a generation operation and a provision operation performed in an information processing device according to an embodiment;

FIG. 2 is a diagram illustrating an exemplary configuration of the information processing device according to the embodiment;

FIG. 3 is a diagram illustrating an example of the information registered in a first-type graph database according to the embodiment;

FIG. 4 is a diagram illustrating an example of the information registered in a second-type graph database according to the embodiment;

FIG. 5 is a diagram illustrating exemplary matrices corresponding to graphs according to the embodiment;

FIG. 6 is a flowchart for explaining an exemplary flow of operations during the generation operation and the provision operation performed according to the embodiment; and

FIG. 7 is a diagram illustrating an exemplary hardware configuration.

### DETAILED DESCRIPTION OF THE PREFERRED EMBODIMENTS

An exemplary illustrative embodiment (hereinafter, called an embodiment) of an information processing device, an information processing method, and a non-transitory computer-readable recording medium having stored therein an information processing program according to the application concerned is described below in detail with reference to the accompanying drawings. However, the information processing device, the information processing method, and the information processing program according to the application concerned are not limited by the embodiment described below.

### Embodiment

1. Example of Information Processing Device

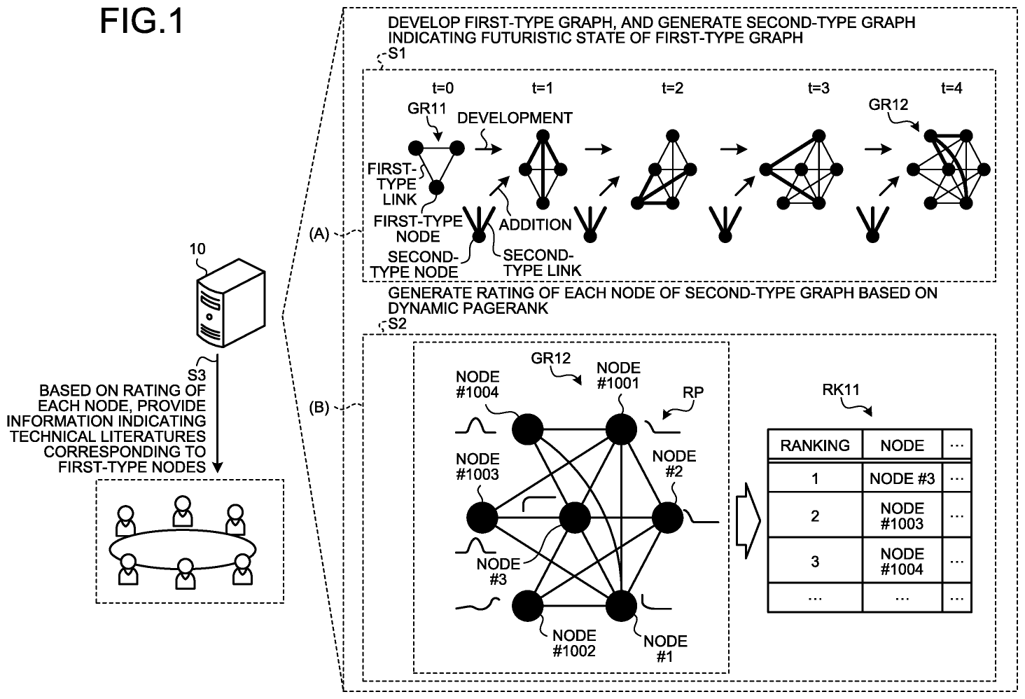

Firstly, explained below with reference to FIG. 1 is an example of an information processing device that performs a generation operation and a provision operation. FIG. 1 is a diagram illustrating an example of the generation operation and the provision operation performed in the information processing device according to the embodiment. With reference to FIG. 1, an information processing device 10 performs the generation operation and the provision operation as described below, and is implemented using, for example, a server device or a cloud system.

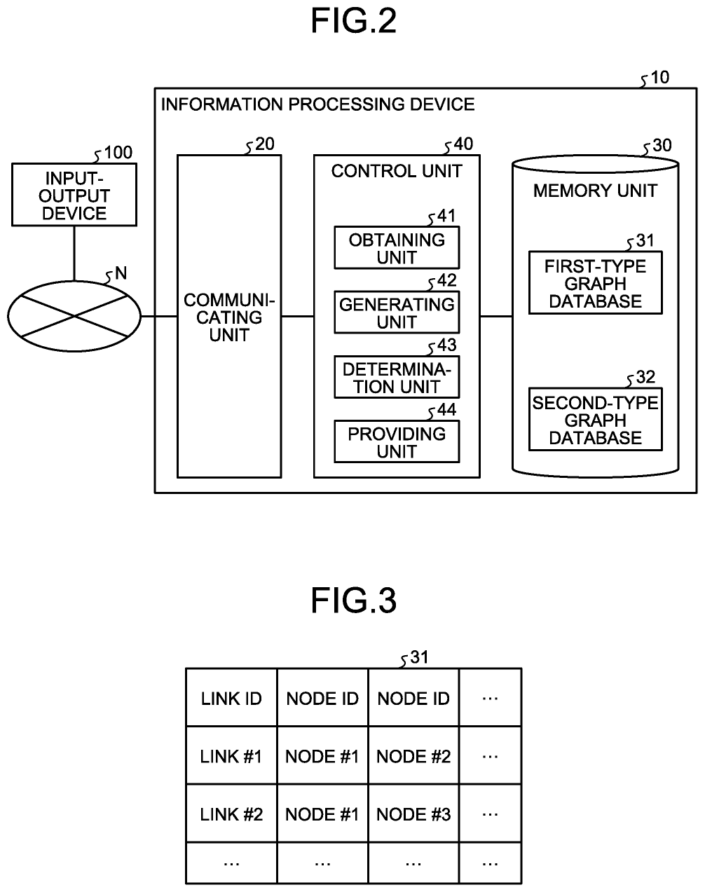

More particularly, the information processing device 10 can communicate with arbitrary devices such as an input-output device 100 (for example, see FIG. 2) via a predetermined network N such as the Internet. The input-output device 100 obtains the utterances of users with the use of a speech obtaining device such as a microphone meant for obtaining speech. Then, the input-output device 100 converts the utterances into text data using an arbitrary speech recognition technology; and sends the text data, which is obtained by conversion, to the information processing device 10. Moreover, the input-output device 100 uses a speech output device such as a speaker and reads out the text data received from the information processing device 10. Moreover, the input-output device 100 can display the text data, which is received from the information processing device 10, in a predetermined display device.

The input-output device 100 is implemented using an information processing device such as a smart device including a smartphone or a tablet; a desktop personal computer (PC) or a notebook PC; or a server device. Alternatively, for example, the input-output device 100 can be implemented using the same information processing device or using a device such as a robot.

2. Regarding Generation Operation and Provision Operation Performed in Information Processing Device

It is possible to think of a case in which information is provided to the users based on the current rating of the elements such as technical literature including research papers, and interaction and ideas of the users are stimulated based on the provided information. However, in such a technology, the information is based only on the rating at the present time, and there is a risk of not being able to provide information related to the technology that would progress in future or related to the targets having the potential to develop due to new ideas (the targets likely to have innovation).

If targets such as technical fields that are expected to grow in future are predicted and if the predicted technical fields are proposed as the main subject of interaction among the users, then it is predicted that the interaction among the users such as brainstorming can be streamlined. However, by providing only the technical fields having a high rating at the point of time of providing the information, it cannot be said that interaction among the users can always be streamlined. For example, there are times when the targets (the technical fields) that have already been matured at the point of time of providing the information have a high rating at that point of time, but are not likely to lead to development of new technology or have poor potential for expansion. In such a case, even if the information related to such targets is provided, there is only a small possibility that a new technology comes into being from interaction or ideas, and thus sometimes it cannot be said that the provided information is appropriate. That is, if a field having poor potential for expansion is proposed, then a new innovative technology may not come into being from the interaction among the users.

2-1. Regarding Generation Operation Performed in Information Processing Device

In that regard, the information processing device 10 develops a graph and rates each target in the developed stage. Thus, the information processing device 10 rates each target by taking into account the future progress, and provides information based on that rating result. For that, the information processing device 10 performs the generation operation described below. In the following explanation, a pre-development graph is called a first-type graph, and a graph obtained after developing the first-type graph is called a second-type graph. In other words, a first-type graph indicates the graph at the point of time of performing the generation operation (the present time), and a second-type graph indicates a futuristic state of the first-type graph, that is, indicates a futuristic graph predicted based on the first-type graph at the present time.

In the following explanation, nodes included in the first-type graph as well as the second-type graph are called first-type nodes, and nodes included only in the second-type graph are called second-type nodes. In other words, a first-type node corresponds to an element that is already treated as a target at the point of time of performing the generation operation (at the present time); and a second-type node corresponds to a futuristic element that would be added as a result of performing the operation for developing the graph, that is, a second-type node corresponds to a virtual element. Moreover, in the following explanation, links included in the first-type graph as well as the second-type graph are called first-type links, and links included only in the second-type graph are called second-type links. In other words, a link that joins two first-type nodes serves as a first-type link, and a link that joins a second-type node to another node (a first-type node or a second-type node) serves as a second-type link.

In the information processing device 10, various targets can be treated as elements, and a first-type graph can be used that includes first-type nodes corresponding to those targets. For example, in the information processing device 10, documents related to technologies can be treated as elements, and a first-type graph can be used that includes first-type nodes corresponding to those elements. For example, in the information processing device 10, technical literatures can be treated as elements, and a first-type graph can be used that includes first-type nodes corresponding to those elements. Moreover, in the information processing device 10, patented inventions or patent applications can be treated as elements, and a first-type graph can be used that includes first-type nodes corresponding to those elements. Furthermore, in the information processing device 10, a single research paper can be treated as a single technical element, and a first-type graph can be generated by using links to join the research papers having citation relationships. Moreover, in the information processing device 10, a plurality of research papers having commonalities can be treated as a single element. Furthermore, in the information processing device 10, instead of using the citation relationships, based on the similarity of keywords mentioned in the documents, a first-type graph can be generated using links to join the documents having similarity. The following explanation is given for an example in which the elements corresponding to nodes represent technical literatures.

For example, the information processing device 10 can implement w2v (word2vec) or s2v (sentence2vec), and convert the words or the sentences in the technical literature into vectors (multidimensional quantities). For example, the information processing device 10 can implement w2v or s2v for converting the words or the sentences in the technical literature into vectors (multidimensional quantities), and then accordingly can generate a vector for each technical literature. For example, the information processing device 10 can perform morphological analysis for extracting word groups from the technical literatures obtained from external devices; convert the extracted words into vectors; and generate the vector for each technical literature based on the vectors for words. Moreover, for example, the information processing device 10 can perform various operations using the vectors for technical literatures. For example, the information processing device 10 can perform various operations by comparing the vectors for technical literatures. For example, the information processing device 10 can derive the distances among the technical literatures using the vectors for technical literatures.

Moreover, the information processing device 10 generates, from a first-type graph, a second-type graph indicating a futuristic state of the first-type graph. The information processing device 10 develops the first-type graph and generates a second-type graph by adding second-type nodes and second-type links in the first-type graph. Herein, the information processing device 10 develops the first-type graph in which the first-type nodes are joined by the first-type links, and generates a second-type graph by adding second-type nodes and second-type links in the first-type graph. Thus, the information processing device 10 generates a second-type graph by adding, in the first-type graph, second-type nodes that correspond to futuristic technical literatures, that is, correspond to virtual technical literatures.

For example, in the information processing device 10, based on the Barabasi-Albert model, would-be-generated nodes corresponding to futuristic elements are predicted and nodes (second-type nodes) are added to the first-type graph, and a second-type graph is generated as a result of developing the first-type graph. For example, in the information processing device 10, would-be-generated nodes can be added as second-type nodes in a graph. For example, the information processing device 10 uses, as a first-type graph, a complete graph Kₘ made of m number of vertexes (where m is an arbitrary natural number equal to or greater than 1). Then, the information processing device 10 adds a single new vertex (node). Subsequently, the information processing device 10 lays edges from the new vertex (node) to the existing m number of vertexes. For example, the information processing device 10 joins a predetermined number of links from the new vertex (a second-type node) to the existing vertexes (nodes). At that time, the probability of having an edge (link) laid is proportional to an order k of the concerned vertex (node) at that point of time. For example, according to the order of each node at the point of time of joining a link from the newly-added node, the information processing device 10 joins a link from the newly-added node. At the point of time of joining links from the newly-added node, the information processing device 10 joins links from the newly-added node to the other nodes in such a way that the links from the newly-added node to the nodes having high orders are easily joined. The information processing device 10 repeatedly performs the operation of adding a new node and joining the links, until the number of nodes reaches a predetermined count (such as 10000).

In the example illustrated in section (A) in FIG. 1, the information processing device 10 develops a first-type graph GR11 and thus generates a second-type graph GR12. For example, in the first-type graph GR11 illustrated in section (A) in FIG. 1; circular figures “●” represent nodes, and edges (lines) joining the circular figures indicate links. In an identical manner, nodes and links are illustrated in other graphs too. The first-type graph GR11 illustrated in section (A) in FIG. 1 includes three nodes and three links as illustrated. More particularly, the first-type graph G11 includes three first-type nodes #1, #2, and #3; and includes three first-type links joining the first-type nodes. In the first-type graph GR11 illustrated in FIG. 1, only three nodes and only three links are illustrated for ease of explanation. However, the first-type graph GR11 can include a large number of nodes (for example, 1000) that is greater than three.

In section (A) in FIG. 1, “t” illustrated above each graph indicates the development process of the concerned graph. Herein, it is indicated that, greater the value of “t”, the farther is the futuristic point of time to which the concerned graph corresponds. For example, the first-type graph G11 corresponding to the point of time before development indicates a graph at the point of time of t=0. Moreover, the graph corresponding to each of the points of time of t=1, t=2, t=3, and t=4 corresponds to a developed-graph state attained by sequentially adding a second-type node.

The information processing device 10 adds, to the first-type graph GR11, a single second-type node and three links emerging from that second-type node so as to develop the first-type graph GR11, and generates a second-type graph corresponding to t=1. Moreover, the information processing device 10 adds, to the second-type graph corresponding to t=1, a single second-type node and three links emerging from that second-type node so as to develop the second-type graph corresponding to t=1, and generates a second-type graph corresponding to t=2. Furthermore, the information processing device 10 adds, to the second-type graph corresponding to t=2, a single second-type node and three links emerging from that second-type node so as to develop the second-type graph corresponding to t=2, and generates a second-type graph corresponding to t=3. Moreover, the information processing device 10 adds, to the second-type graph corresponding to t=3, a single second-type node and three links emerging from that second-type node so as to develop the second-type graph corresponding to t=3, and generates the second-type graph GR12 corresponding to t=4. As a result, the information processing device 10 generates the second-type graph GR12 that indicates a futuristic state of the first-type graph GR11. Meanwhile, the number of second-type links joined to a single second-type node is not limited to three, and there can be various numbers of links such as 10 links.

Herein, as long as the information processing device 10 can generate, from a first-type graph, a second-type graph indicating a futuristic state of the first-type graph; the method is not limited to be based on the Barabasi-Albert model and any other method can be implemented. For example, as long as a generated second-type graph satisfies the conditions related to the scale-free property, the information processing device 10 can implement any method. Moreover, for example, as long as the conditions for preferential selection are satisfied, the information processing device 10 can implement any method. Furthermore, for example, as long as it becomes easier for a newly-added node to get linked to nodes having high orders, the information processing device 10 can implement any method. Moreover, for example, as long as it becomes easier for a newly-added node to get linked to a node having a high number of already-linked nodes, the information processing device 10 can implement any method. Meanwhile, the first-type graphs are not limited to be complete graphs, and the information processing device 10 can generate second-type graphs using various other types of graphs. For example, the information processing device 10 can use, as a first-type graph, a graph in which each node is linked to some nodes.

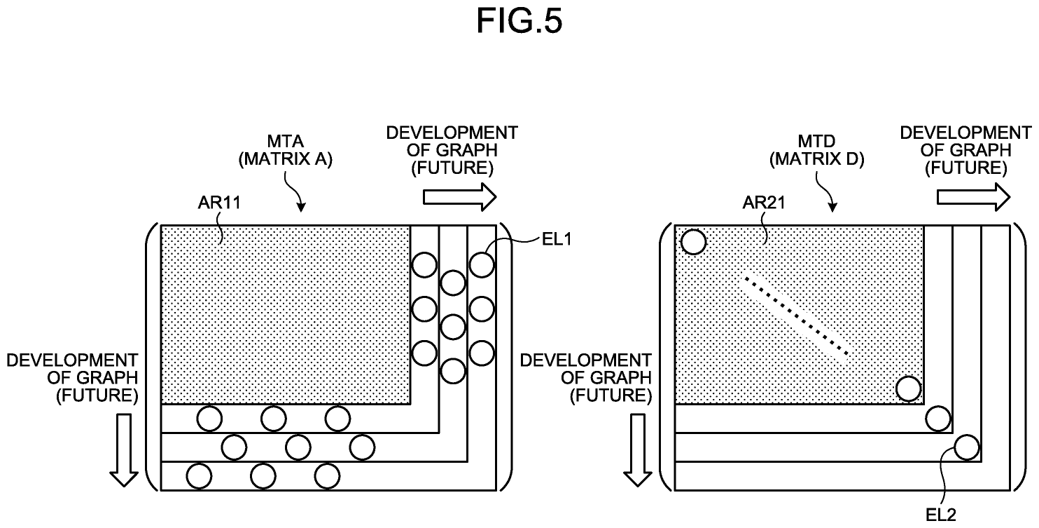

Herein, a second-type graph obtained by developing a first-type graph can be expanded (expressed) as a matrix MTA (hereinafter, also called a “matrix A”) or as a matrix MTD (hereinafter, also called a “matrix D”) as illustrated in FIG. 5. FIG. 5 is a diagram illustrating exemplary matrices corresponding to graphs according to the embodiment.

The matrix A illustrated in FIG. 5 is, what is called, an adjacency matrix used in expressing a graph. For example, depending on the presence or absence of a link between vertexes v and w, a predetermined value is assigned to the component (v, w) of the matrix. For example, in the matrix A, diagonal components (for example, the component (1, 1) becomes equal to “0”. For example, when a link is set between the nodes #1 and #2, predetermined values are assigned to those components in the matrix A which correspond to the nodes #1 and #2. For example, when a link is set between the nodes #1 and #2, “1” is assigned to the components (1, 2) and (2, 1) in the matrix A. Alternatively, for example, when a link is set between the nodes #1 and #2, a value based on the distance between the nodes 1 and 2 can be assigned to the components (1, 2) and (2, 1) in the matrix A. For example, to the components (1, 2) and (2, 1) in the matrix A, a value can be assigned that is calculated by a predetermined distance function using the vector of the node #1 and the vector of the node #2 as variables. For example, when a link is set between the nodes #1 and #3, “0” is assigned to the components (1, 3) and (3, 1) of the matrix A. In this way, regarding a “node #*”, “* (where * is an arbitrary natural number)” may correspond to a row or a column of the matrix. However, as long as each node corresponds to a row or a column, “*” can have any type of correspondence. Moreover, if a graph is a directed graph or if each link is weighted, then the matrix A becomes a matrix including components according to its form.

In the matrix A illustrated in FIG. 5, a range AR11 (a hatched portion) corresponds to first-type nodes of the first-type graph before graph development is carried out. That is, in the matrix A illustrated in FIG. 5, the range other than the range AR11 corresponds to the components related to futuristic states attributed to graph development. In the matrix A illustrated in FIG. 5, the portions illustrated by circular figures such as a component EL1 represent the components to which values other than “0” are assigned as a result of graph development. For example, in the matrix A illustrated in FIG. 5, the portions illustrated by circular figures such as the component EL1 indicate the components to which “1” is assigned as a result of graph development. When a link is set between the node #1, which is a first-type node, and a node #1001, which is a second-type node; “1” is assigned to the components (1, 1001) and (1001, 1) in the matrix A. In this way, the matrix A illustrated in FIG. 5 includes information in which futuristic states are taken into account.

The matrix D illustrated in FIG. 5 is used for expressing a graph and, for example, can be an order matrix (a degree matrix). For example, the matrix D illustrated in FIG. 5 indicates the order (degree) of each node. For example, the order of a particular vertex v is assigned to the component (v, v) of the matrix. For example, in the matrix D, the components other than the diagonal components become equal to “0”. For example, when the node #1 has three nodes joined thereto by links, then “3” is assigned to the component (1, 1) of the matrix D. In the example illustrated in FIG. 5, the explanation is given about a weightless undirected graph. However, if a graph is a directed graph or if each link is weighted, then the matrix A becomes a matrix including components according to its form.

In the matrix D illustrated in FIG. 5, a range AR21 (a hatched portion) corresponds to first-type nodes of the first-type graph before graph development is carried out. That is, in the matrix D illustrated in FIG. 5, the range other than the range AR21 corresponds to the components related to futuristic states attributed to graph development. In the matrix D illustrated in FIG. 5, the portions illustrated by circular figures such as a component EL2 represent the components to which values other than “0” are assigned as a result of graph development. For example, in the matrix D illustrated in FIG. 5, the portions illustrated by circular figures such as the component EL2 indicate the components to which the order of the corresponding node is assigned as a result of graph development. For example, when three links are joined from the node #1001, which is a second-type node, to other nodes; then “3” is assigned to the component (1001, 1001) in the matrix D. Moreover, the components corresponding to the other nodes to which three links are joined from the node #1001, which represents a second-type node, also get updated in the matrix D. For example, regarding the node (for example, the node #3) to which a single link is newly joined from the node #1001 representing a second-type node, “1” is added to the corresponding component (3, 3) in the matrix D. In this way, the matrix D illustrated in FIG. 5 includes the information in which the original state is taken into account. Meanwhile, it can be the information processing device 10 that generates the matrices A and D.

Then, the information processing device 10 refers to the information of the matrices A and D, and generates rating information for each node of the second-type graph. For example, the information processing device 10 generates rating information for each node based on the number of links joined to that node and based on the other nodes. The information processing device 10 generates rating information for each node of the second-type graph based on Dynamic PageRank. For example, the information processing device 10 generates a rating function for each node of the second-type graph based on Dynamic PageRank. For example, the information processing device 10 implements the Dynamic PageRank technology as disclosed in Non-patent Literature 1 or Non-patent Literature 2, and generates a rating function for each node of the second-type graph. For example, the information processing device 10 applies the method disclosed in Non-patent Literature 1 or Non-patent Literature 2 with respect to each node of the second-type graph, and generates a rating function for each node of the second-type graph.

For example, using Equation (1) given below, the information processing device 10 generates information indicating the probability of transition from each node to another node.

P=A^{T}D⁻¹ (1)

In Equation (1), “A^{T}” represents the transpose of the matrix A. Moreover, in Equation (1), “D⁻¹” represents the inverse matrix of the matrix D. Based on the transpose A^{T} of the matrix A and the inverse matrix D⁻¹ of the matrix D, the information processing device 10 derives a matrix P that indicates the probability of transition from each node to another node. For example, in the matrix P, “P_{i, j}” indicates the probability of transition from a node i to a node j. Meanwhile, the information processing device 10 can also use a predetermined attenuation parameter “α” as given below in Equation (2). In Equation (2), the attenuation parameter “α” can be set to have an appropriate value such as “0.85” or “0.9”.

αP+(1−α)ve^{T} (2)

For example, as described above, the information processing device 10 implements the Dynamic PageRank technology as disclosed in Non-patent Literature 1 or Non-patent Literature 2, and generates rating information for each node of the second-type graph GR12. Based on Dynamic PageRank, the information processing device 10 generates a rating function for each node of the second-type graph GR12. Then, as illustrated in section (B) in FIG. 1, based on the rating information for each node of the second-type graph GR12, the information processing device 10 generates probability distribution information related to the rating of each node. For example, as illustrated in a probability distribution RP corresponding to the node #1001 in the second-type graph GR12, the information processing device 10 generates probability distribution information related to the rating of each node.

Thus, the rating function and the probability distribution information of each node of the second-type graph GR12 indicates the information in which the rating of each node after the development of the first-type graph GR11 is reflected, that is, indicates the information in which the rating of each node at a futuristic point of time is reflected. Hence, the information indicating the rating of each node of the second-type graph GR12 can be treated as the indicator of the types of technical literatures that would be recognized in future or as the indicator of the technical fields that are likely to advance in future. That is, the information indicating the rating of each node of the second-type graph GR12 represents information that is desirably provided to the users as information indicating the promising targets in future, such as the fields in which a new innovative technology is highly likely to be created during the interaction among the users or the fields having high potential for expansion.

3. Example of Operations Performed in the Information Processing Device

Explained below with reference to FIG. 1 is the generation operation and the provision operation performed in the information processing device 10. Firstly, the explanation is given for an example of the generation operation performed in the information processing device 10.

Firstly, the information processing device 10 develops a first-type graph and generates a second-type graph representing a futuristic state of the first-type graph (Step S1). For example, the information processing device 10 adds second-type nodes and second-type links in the first-type graph and generates a second-type graph. Herein, based on the Barabasi-Albert model, the information processing device 10 predicts would-be-generated nodes corresponding to futuristic elements, and generates a second-type graph by adding second-type nodes and developing the first-type graph.

For example, as illustrated in section (A) in FIG. 1, the information processing device 10 develops the first-type graph GR11 and generates the second-type graph GR12. In the example illustrated in FIG. 1, the information processing device 10 sequentially adds second-type nodes at timings from t=0 to t=4, and generates the second-type graph GR12 from the first-type graph GR11. For example, in an addition operation performed after every increment of “t”, the information processing device sequentially adds a single second-type node and three second-type links, and generates the second-type graph GR12. More particularly, in a single instance of the addition operation, the information processing device 10 adds a single second-type node and three second-type links joining that second-type node to other nodes.

For example, in the information processing device 10, in a single instance of the addition operation, “1” is assigned to the concerned components in the matrix A. Moreover, in the information processing device 10, in a single instance of the addition operation, a predetermined value is assigned to the diagonal component corresponding to the newly-added second-type node in the matrix D, and the diagonal components corresponding to the other nodes to which links are joined from the newly-added second-type node are updated in the matrix D. With reference to FIG. 1, in a single instance of the addition operation performed in the information processing device 10, “3” is assigned to the diagonal component corresponding to the newly-added second-type node in the matrix D. Moreover, in a single instance of the addition operation performed in the information processing device 10, “1” is added to the diagonal components corresponding to the other nodes to which links are joined from the newly-added second-type node.

The information processing device 10 generates the rating of each node of the second-type graph GR12 based on Dynamic PageRank (Step S2). For example, the information processing device 10 implements the Dynamic PageRank technology as disclosed in Non-patent Literature 1 or Non-patent Literature 2, and generates a rating function for each node of the second-type graph GR12. Thus, based on Dynamic PageRank, the information processing device 10 generates a rating function for each of nodes #1 to #3 and nodes #1001 to #1004. For example, the information processing device 10 generates a rating function in which time is treated as a variable. Then, as illustrated in section (B) in FIG. 1, based on the rating function for each node of the generated second-type graph GR12, the information processing device 10 generates probability distribution information related to the rating of each node. For example, the information processing device 10 generates probability distribution information related to the rating of each node, such as the probability distribution RP corresponding to the node #1001 of the second-type graph GR12.

Subsequently, the information processing device 10 ranks the nodes of the second-type graph GR12. For example, the information processing device 10 appropriately implements various conventional technologies such as Dynamic PageRank, and ranks the nodes of the second-type graph GR12. Alternatively, the information processing device 10 can rank the nodes of the second-type graph GR12 using the rating function and the probability distribution information regarding each node. For example, the information processing device 10 can rank the nodes of the second-type graph GR12 based on the values at a predetermined timing (point of time) or based on the maximum values. With reference to FIG. 1, as illustrated in ranking information RK11, the nodes #1 to #3 and the nodes #1001 to #1004 are ranked. Herein, the information processing device 10 ranks the nodes in order of the nodes #3, #1003, and #1004. That is, the information processing device 10 determines that the rating is high in order of the nodes #3, #1003, and #1004. Then, based on the rating of the nodes, the information processing device 10 determines on the information related to the second-type graph to be provided.

Subsequently, based on the rating of each node, the information processing device 10 provides information indicating the technical literatures corresponding to first-type nodes (Step S3). In the example illustrated in FIG. 1, as illustrated in the ranking information RK11, the information processing device 10 determines to provide the information related to the node #3 that represents the first-type node having the highest ranking. Then, the information processing device 10 provides the information indicating the node #3. Thus, the information processing device 10 provides information indicating technical literature #3 corresponding to the node #3. In this way, from among the first-type nodes included in the second-type graph GR12 and the first-type graph GR11, the information processing device 10 provides the information indicating the node #3 having the highest rating. As a result, the information processing device 10 can propose, as the target for interaction and ideas, the technical literature of the field expected to have more growth. Hence, in the technical strategy planning or in the theme selection during brainstorming, the theme useful for deriving innovation can be identified and provided to the user. That is, the information processing device 10 can appropriately provide the information that is based on the rating obtained by taking the future into account.

In the example illustrated in FIG. 1, the information processing device 10 provides the information indicating a first-type node having a high rating. However, the embodiment is not limited to that example. For example, the information processing device 10 can provide the information indicating such a first-type node, from among the first-type nodes, to which the second-type nodes having a high rating are joined. For example, the information processing device 10 can provide the information indicating the node #1 that is the first-type node to which the node #1003 representing the second-type node having the second highest ranking and the node #1004 representing the second-type node having the third highest ranking are joined. As a result, the information processing device 10 can provide, to the users, the information indicating the existing elements (the first-type nodes) that serve as the basis of futuristic elements having a high rating, and thus can provide the information indicating the existing technology that is used in deriving the innovation of the users. As a result, the information processing device 10 can appropriately provide the information based on the rating obtained by taking the future into account.

4. Configuration of Information Processing Device

Given below is the explanation of an exemplary functional configuration of the information processing device 10 that performs the generation operation and the provision operation. FIG. 2 is a diagram illustrating an exemplary configuration of the information processing device according to the embodiment. As illustrated in FIG. 2, the information processing device 10 includes a communicating unit 20, a memory unit 30, and a control unit 40.

The communicating unit 20 is implemented using, for example, a network interface card (NIC). Moreover, the communicating unit 20 is connected to a network N in a wired manner or in a wireless manner, and sends information to and receives information from the input-output device 100 and the terminal devices (not illustrated) of the users.

The memory unit 30 is implemented using a semiconductor memory device such as a random access memory (RAM) or a flash memory; or using a memory device such as a hard disc or an optical disc. The memory unit 30 is used to store a first-type graph database 31 and a second-type graph database 32. However, the memory unit 30 is not limited to store the first-type graph database 31 and the second-type graph database 32, and can be used store a variety of other information. For example, the memory unit 30 is used to store information indicating the correspondence of the nodes in the first-type graph database 31 (first-type nodes) with the elements such as technical literatures. Meanwhile, the memory unit 30 can also be used to store vector data of each node.

In the first-type graph database 31, a variety of information related to a first-type graph is stored. For example, FIG. 3 is a diagram illustrating an example of the information registered in the first-type graph database according to the embodiment. In the example illustrated in FIG. 3, in the first-type graph database 31, information containing a “link ID (Identifier)” item and a “node ID” item is registered.

The “link ID” item represents information meant for identifying the links included in the graph. The “node ID” item represents information meant for identifying the nodes that are connected by the links indicated in a corresponding manner in the “link ID” item, that is, information meant for identifying the nodes indicating two elements such as two technical literatures having a relationship.

For example, in the example illustrated in FIG. 3, regarding a link ID “link #1”, node IDs “node #1” and “node #2” are registered in a corresponding manner. Such information indicates that the node identified by the node ID “node #1” and the node identified by the node ID “node #2” are connected by the link identified by the link ID “link #1”.

In the example illustrated in FIG. 3, conceptual values such as “link #1” and “node #1” are written. However, in practice, character strings or numerical values representing the links and the nodes are registered. Moreover, the information indicated in FIG. 3 is only exemplary. That is, in the first-type graph database 31, data of any arbitrary format can be registered as long as the data has a graph structure.

In the first-type graph database 31, the first-type graphs can be registered according to the technical fields (categories). For example, in the first-type graph database 31, a first-type graph for each technical field can be registered in which research papers belonging to that technical field (category) are treated as the nodes and the citation relationships among the research papers are treated as the links. Meanwhile, a link can indicate the relationship between the reference source and the reference destination, that is, a link can be a directional link. In that case, the corresponding first-type graph can be a directed graph.

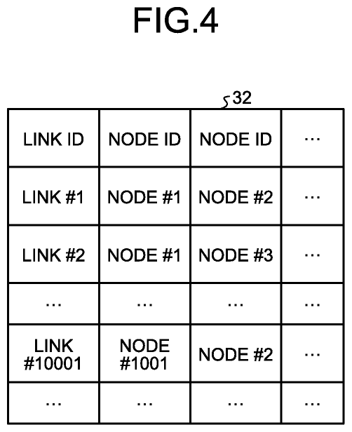

In the second-type graph database 32, a variety of information related to the second-type graphs is registered. For example, FIG. 4 is a diagram illustrating an example of the information registered in the second-type graph database according to the embodiment. In the example illustrated in FIG. 4, in the second-type graph database 32, information containing a “link ID (Identifier)” item and a “node ID” item is registered.

The “link ID” item represents information meant for identifying the links included in the graph. The “node ID” item represents information meant for identifying the nodes that are connected by the links indicated in a corresponding manner in the “link ID” item, that is, the nodes indicating two elements such as two technical literatures (research papers) having a relationship.

For example, in the example illustrated in FIG. 4, regarding a link ID “link #10001”, node IDs “node #1001” and “node #2” are registered in a corresponding manner. Such information indicates that the node identified by the node ID “node #1001” and the node identified by the node ID “node #2” are connected by the link identified by the link ID “link #10001”.

In the example illustrated in FIG. 4, conceptual values such as “link #10001” and “node #1” are written. However, in practice, character strings or numerical values representing the links and the nodes are registered. Moreover, the information indicated in FIG. 4 is only exemplary. That is, in the second-type graph database 32, data of any arbitrary format can be registered as long as the data has a graph structure.

In the second-type graph database 32, the second-type graphs can be registered according to the technical fields (categories). For example, in the second-type graph database 32, a second-type graph for each technical field can be registered in which research papers belonging to that technical field (category) are treated as the nodes and the citation relationships among the research papers are treated as the links. Moreover, in the second-type graph database 32, information enabling identification about whether each node is a first-type node or a second-type node can be registered. Furthermore, in the second-type graph database 32, information enabling identification about whether each link is a first-type link or a second-type link can be registered. Meanwhile, a link can indicate the relationship between the reference source and the reference destination, that is, a link can be a directional link. In that case, the corresponding second-type graph can be a directed graph.

Returning to the explanation with reference to FIG. 2, the control unit 40 is a controller that is implemented when a processor such as a central processing unit (CPU) or a micro processing unit (MPU) executes various computer programs, which are stored in an internal memory device of the information processing device 10, using the RAM as the work area. Alternatively, the control unit 40 can be a controller that is implemented using an integrated circuit such as an application specific integrated circuit (ASIC) or a field programmable gate array (FPGA).

As illustrated in FIG. 2, the control unit 40 includes an obtaining unit 41, a generating unit 42, a determination unit 43, and a providing unit 44; and performs the generation operation and the provision operation described earlier. For example, the generating unit 42 performs the generation operation, and the providing unit 44 performs the provision operation.

The obtaining unit 41 obtains a variety of information. That is, the obtaining unit 41 obtains a variety of information required to perform the generation operation and the provision operation. For example, the obtaining unit 41 obtains a variety of information from the memory unit 30. Moreover, for example, the obtaining unit 41 obtains a variety of information from the first-type graph database 31 and the second-type graph database 32. Furthermore, the obtaining unit 41 obtains a variety of information from external information processing devices. For example, the obtaining unit 41 obtains a variety of information from external devices such as the input-output device 100.

The obtaining unit 41 obtains first-type graphs. Herein, the obtaining unit 41 obtains first-type graphs from external devices or from the first-type graph database 31. For example, the obtaining unit 41 obtains first-type graphs in which technical literatures related to various categories such as healthcare, physics, and cooking are treated as nodes. That is, the obtaining unit 41 obtains first-type graphs in which research papers related to various categories such as healthcare, physics, and cooking are treated as nodes. The obtaining unit 41 obtains first-type graphs in which the technical literatures are treated as the nodes and the citation relationships among the technical literatures are treated as the links. Moreover, the obtaining unit 41 obtains second-type graphs. Herein, the obtaining unit 41 obtains second-type graphs from the second-type graph database 32.

The generating unit 42 generates a variety of information. That is, the generating unit 42 generates a variety of information based on a variety of information obtained by the obtaining unit 41. For example, the generating unit 42 generates a variety of information based on a variety of information stored in the memory unit 30. For example, the generating unit 42 generates a variety of information based on the information stored in the first-type graph database 31 and the second-type graph database 32. Moreover, the generating unit 42 generates a variety of information based on a variety of information determined by the determination unit 43.

The generating unit 42 generates a rating function for each node of a second-type graph that is generated from a first-type graph, in which predetermined elements are treated as nodes and the relationships among the elements are treated as links, and that indicates a futuristic state of the first-type graph. The generating unit 42 generates the rating function for each node based on Dynamic PageRank. The generating unit 42 predicts would-be-generated nodes corresponding to futuristic elements based on the Barabasi-Albert model, and generates a second-type graph by adding nodes and developing the first-type graph.

The generating unit 42 generates rating information, which indicates the rating of each node, based on the joining relationships among the nodes of a second-type graph that is formed when second-type nodes and second-type links, which are meant for joining the second-type nodes to other nodes, are added to a first-type graph by developing the first-type graph that includes first-type nodes corresponding to predetermined targets and includes first-type links for joining the first-type nodes based on the relationships among the targets. The generating unit 42 generates rating information, which indicates the rating of each node, based on the joining relationships among the nodes of a second-type graph that is generated when second-type nodes, which correspond to virtual targets different than the targets in the first-type graph, and second-type links are added in the first-type graph. The generating unit 42 develops the first-type graph based on the Barabasi-Albert model, and generates a second-type graph by adding second-type nodes and second-type links in the first-type graphs.

The generating unit 42 generates rating information for each node based on Dynamic PageRank. That is, the generating unit 42 generates the probability distribution, which represents the rating information assigned to each node, based on Dynamic PageRank. The generating unit 42 generates the probability distribution based on the rating function assigned to each node according to Dynamic PageRank. Alternatively, instead of using Dynamic PageRank, the generating unit 42 can implement various other methods and generate rating information for each node. For example, as long as the nodes of a graph including futuristic nodes can be rated, the generating unit 42 can generate rating information for each node according to any rating method. For example, the generating unit 42 can generate rating method for each node based on the link count (order) of each node and the joint nodes. For example, the generating unit 42 can generate rating information for each node in such a way that, higher the link count (order) of a node, the higher is the rating of the concerned node. For example, the generating unit 42 can generate rating information for each node in such a way that, higher the number of joint nodes having a high rating, the higher is the rating of the concerned node. For example, the generating unit 42 can generate rating information for each node using the PageRank method.

With reference to FIG. 1, the generating unit 42 develops the first-type graph GR11 and generates the second-type graph GR12. Thus, the generating unit 42 develops a first-type graph, and generates a second-type graph indicating a futuristic state of the first-type graph. For example, the generating unit 42 adds second-type nodes and second-type links in the first-type graph, and generates a second-type graph. Herein, based on the Barabasi-Albert model, the generating unit 42 predicts would-be-generated nodes corresponding to futuristic elements, and generates a second-type graph by adding second-type nodes and developing the first-type graph.

For example, as illustrated in section (A) in FIG. 1, the generating unit 42 develops the first-type graph GR11 and generates the second-type graph GR12. The generating unit 42 sequentially adds second-type nodes at timings from t=0 to t=4, and generates the second-type graph GR12 from the first-type graph GR11.

The generating unit 42 generates the rating of each node of the second-type graph GR12 based on Dynamic PageRank. For example, the generating unit 42 implements the Dynamic PageRank technology as disclosed in Non-patent Literature 1 or Non-patent Literature 2, and generates a rating function for each node of the second-type graph GR12. Herein, the generating unit 42 generates rating functions for the nodes #1 to #3 and the nodes #1001 to #1004 based on Dynamic PageRank. For example, the generating unit 42 generates rating functions in which time is treated as a variable. Then, as illustrated in section (B) in FIG. 1, the generating unit 42 generates probability distribution information, which is related to the rating of each node, based on the rating function for each node of the second-type graph GR12. For example, as illustrated in the probability distribution RP corresponding to the node #1001 in the second-type graph GR12, the generating unit 42 generates probability distribution information related to the rating of each node.

The determination unit 43 determines on a variety of information. Herein, the determination unit 43 determines on a variety of information based on a variety of information obtained by the obtaining unit 41. For example, the determination unit 43 determines on a variety of information based on a variety of information stored in the memory unit 30. For example, the determination unit 43 determines on a variety of information based on the information stored in the first-type graph database 31 and the second-type graph database 32. Moreover, the determination unit 43 determines on a variety of information based on a variety of information generated by the generating unit 42.

The determination unit 43 determines on the nodes for information provision. The determination unit 43 determines on the technical literatures for information provision. With reference to FIG. 1, the determination unit 43 determines that the rating is high in order of the nodes #3, #1003, and #1004. Then, based on the rating of each node, the determination unit 43 determines on the information related to the second-type graph to be provided. As illustrated in the ranking information RK11, the determination unit 43 determines to provide the information related to the node #3 that represents the first-type node having the highest ranking.

The providing unit 44 provides a variety of information. The providing unit 44 performs the provision operation. The providing unit 44 provides a variety of information to external information processing devices. For example, the providing unit 44 provides a variety of information to external devices such as the input-output device 100. Thus, the providing unit 44 sends a variety of information to external devices. The providing unit 44 delivers a variety of information to external devices. Herein, the providing unit 44 provides a variety of information based on a variety of information obtained by the obtaining unit 41. Moreover, the providing unit 44 provides a variety of information based on a variety of information generated by the generating unit 42. Furthermore, the providing unit 44 provides a variety of information based on a variety of information determined by the determination unit 43.

The providing unit 44 provides the information related to second-type graphs based on the rating information for nodes as generated by the generating unit 42. The providing unit 44 provides the information related to such nodes, from among the first-type nodes included in the second-type graph and the first-type graph, which satisfy a predetermined standard based on the rating functions for the first-type nodes. Moreover, the providing unit 44 provides the information about such nodes, from among the first-type nodes included in the second-type graph and the first-type graph, which are second-type nodes joined to the first-type nodes and whose rating based on the rating functions for the second-type nodes included only in the second-type graph satisfies a predetermined standard. Furthermore, the providing unit 44 provides the information related to the second-type graphs based on the rating information for each node as generated by the generating unit 42. Moreover, the providing unit 44 provides the information related to the nodes whose probability distribution satisfies a predetermined standard.

The providing unit 44 provides the information indicating the technical literatures corresponding to the first-type nodes based on the rating of the nodes. With reference to FIG. 1, the providing unit 44 provides the information indicating the node #3. Thus, the providing unit 44 provides the information indicating the technical literature #3 corresponding to the node #3. For example, the providing unit 44 can provide the information indicating such a first-type node, from among the first-type nodes, to which the second-type nodes having a high rating are joined. For example, the providing unit 44 can provide the information indicating the node #1 that is the first-type node to which the node #1003 representing the second-type node having the second highest ranking and the node #1004 representing the second-type node having the

5. Exemplary Flow of Operations Performed in Information Processing Device

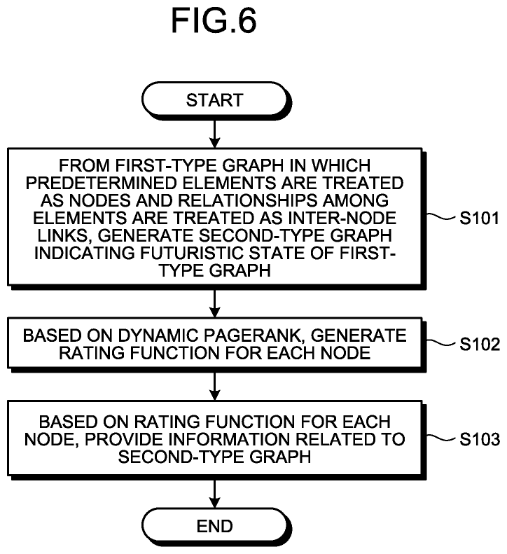

Explained below with reference to FIG. 5 is an exemplary flow of operations during the generation operation and the provision operation performed in the information processing device 10. FIG. 6 is a flowchart for explaining an exemplary flow of operations during the generation operation and the provision operation performed according to the embodiment.

Firstly, the information processing device 10 generates, from a first-type graph in which predetermined elements are treated as nodes and the relationships among the elements are treated as links, a second-type graph indicating a futuristic state of the first-type graph (Step S101). Then, the information processing device 10 generates a rating function for each node based on Dynamic PageRank (Step S102). Subsequently, the information processing device 10 provides the information related to the second-type graph based on the rating function for each node (Step S103).

6. Miscellaneous

Of the processes described in the embodiment, all or part of the processes explained as being performed automatically can be performed manually. Similarly, all or part of the processes explained as being performed manually can be performed automatically by a known method. The processing procedures, the control procedures, specific names, various data, and information including parameters described in the embodiments or illustrated in the drawings can be changed as required unless otherwise specified. For example, the variety of information explained with reference to the drawings is not limited to the information illustrated in the drawings.

The constituent elements of the device illustrated in the drawings are merely conceptual, and need not be physically configured as illustrated. The constituent elements, as a whole or in part, can be separated or integrated either functionally or physically based on various types of loads or use conditions.

Moreover, embodiments can be combined without causing any contradiction in the operation details.

7. Computer Program Product

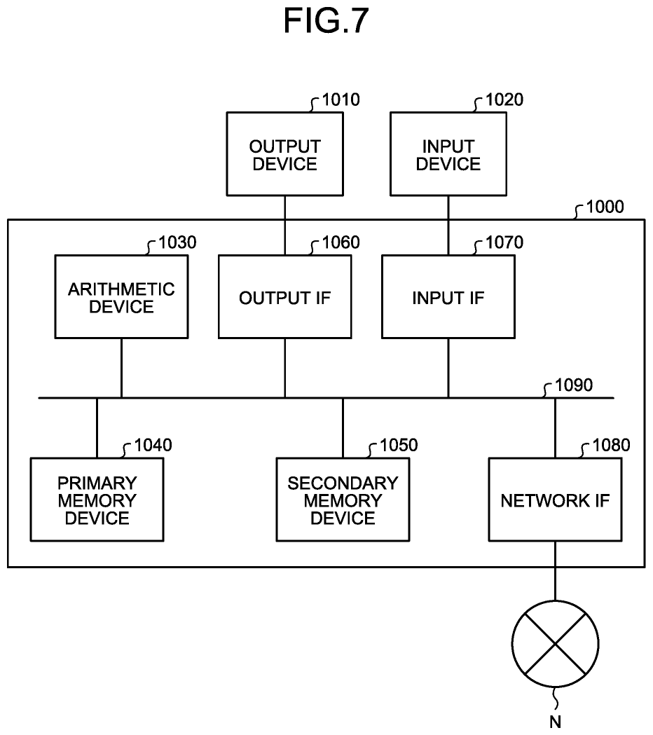

The information processing device 10 according to the embodiment described above is implemented using, for example, a computer 1000 having a configuration as illustrated in FIG. 7. FIG. 7 is a diagram illustrating an exemplary hardware configuration. The computer 1000 is connected to an output device 1010 and an input device 1020, and includes an arithmetic device 1030, a primary memory device 1040, a secondary memory device 1050, an output interface (IF) 1060, an input IF 1070, and a network IF 1080 that are connected to each other by a bus 1090.

The arithmetic device 1030 runs based on computer programs stored in the primary memory device 1040 or the secondary memory device 1050 or based on computer programs read from the input device 1020, and accordingly performs various operations. The primary memory device 1040 is a memory device such as a RAM that is used to temporarily store the data to be used by the arithmetic device 1030 in performing a variety of arithmetic processing. The secondary memory device 1050 is a memory device in which the data to be used by the arithmetic device 1030 in performing a variety of arithmetic processing is stored, and various databases are registered; and is implemented using a read only memory (ROM), a hard disc drive (HDD), or a flash memory.

The output IF 1060 is an interface for enabling transmission of target information for output to the output device 1010 such as a monitor or a printer that outputs a variety of information. For example, the output IF 1060 is implemented using a connector of a particular standard such as the universal serial bus (USB), the digital visual interface (DVI), or the high definition multimedia interface (HDMI, registered trademark). The input IF 1070 is an interface for receiving information from various input devices 1020 such as a mouse, a keyboard, and a scanner; and is implemented using, for example, a USB.

The input device 1020 can read information from an optical recording medium such as a compact disc (CD), a digital versatile disc (DVD), or a phase change rewritable disc (PD); or from a magneto-optical recording medium such as a magneto-optical (MO) disc; or from a tape medium; or from a magnetic recording medium; or from a semiconductor memory. Alternatively, the input device 1020 can be an external memory medium such as a USB memory.

The network IF 1080 receives data from other devices via the network N and sends the data to the arithmetic device 1030; as well as sends the data generated by the arithmetic device 1030 to other devices via the network N.

The arithmetic device 1030 controls the output device 1010 via the output IF 1060 and controls the input device 1020 via the input IF 1070. For example, the arithmetic device 1030 loads computer programs from the input device 1020 or the secondary memory device 1050 into the primary memory device 1040, and executes them.

For example, when the computer 1000 functions as the information processing device 10, the arithmetic device 1030 of the computer 1000 executes computer programs loaded in the primary memory device 1040 and implements the functions of the control unit 40.

8. Effect

As described above, the information processing device 10 according to the embodiment includes the generating unit 42 and the providing unit 44. The generating unit 42 generates a rating function for each node of a second-type graph that is generated from a first-type graph in which predetermined elements are treated as nodes and the relationships among the elements are treated as links, and that indicates a futuristic state of the first-type graph. The providing unit 44 provides the information related to the second-type graph based on the rating function for each node as generated by the generating unit 42.

In this way, in the information processing device 10 according to the embodiment, the information related to a second-type graph is provided based on the rating function for each node of the second-type graph that is generated from a first-type graph in which predetermined elements are treated as nodes and the relationships among the elements are treated as links, and that indicates a futuristic state of the first-type graph. As a result, it becomes possible to appropriately provide the information based on the rating obtained by taking the future into account.

Moreover, in the information processing device 10 according to the embodiment, the generating unit 42 generates the rating function for each node based on Dynamic PageRank.

In this way, in the information processing device 10 according to the embodiment, the rating function for each node is generated based on Dynamic PageRank, so that it becomes possible to appropriately provide the information based on the rating obtained by taking the future into account.

Moreover, in the information processing device 10 according to the embodiment, the generating unit 42 predicts would-be-generated nodes corresponding to futuristic elements based on the Barabasi-Albert model, and generates a second-type graph by adding nodes (second-type nodes) and developing the first-type graph.

In this way, in the information processing device 10 according to the embodiment, would-be-generated nodes corresponding to futuristic elements are predicted based on the Barabasi-Albert model, and a second-type graph is generated by adding nodes (second-type nodes) and developing the first-type graph. As a result, it becomes possible to appropriately provide the information based on the rating obtained by taking the future into account.

Furthermore, in the information processing device 10 according to the embodiment, the providing unit 44 provides the information indicating such nodes, from among the first-type nodes included in the second-type graph and the first-type graph, which satisfy a predetermined standard based on the rating functions for the first-type nodes.

In this way, in the information processing device 10 according to the embodiment, as a result of providing the information indicating such nodes, from among the first-type nodes included in the second-type graph and the first-type graph, which satisfy a predetermined standard based on the rating functions for the first-type nodes; it becomes possible to appropriately provide the information based on the rating obtained by taking the future into account.

Moreover, in the information processing device 10 according to the embodiment, the providing unit 44 provides the information indicating such nodes, from among the first-type nodes included in the second-type graph and the first-type graph, which are second-type nodes joined to first-type nodes and whose rating based on the rating functions for the second-type nodes included only in the second-type graph satisfies a predetermined standard.

In this way, in the information processing device 10 according to the embodiment, as a result of providing the information indicating such nodes, from among the first-type nodes included in the second-type graph and the first-type graph, which are second-type nodes joined to first-type nodes and whose rating based on the rating functions for the second-type nodes included only in the second-type graph satisfies a predetermined standard; it becomes possible to appropriately provide the information based on the rating obtained by taking the future into account.

Meanwhile, in the information processing device 10 according to the embodiment, in a first-type graph, technical literatures are treated as the nodes.

As a result, in the information processing device 10 according to the embodiment, regarding the technical literatures, it becomes possible to appropriately provide the information based on the rating obtained by taking the future into account.

Herein, although the description is given about the embodiment of the application concerned, the technical scope of the present invention is not limited to the embodiment described above, and can be construed as embodying various deletions, alternative constructions, and modifications that may occur to one skilled in the art that fairly fall within the basic teaching herein set forth.

Moreover, the terms “section”, “module”, and “unit” mentioned above can be read as “device” or “circuit”. For example, an obtaining unit can be read as an obtaining device or an obtaining circuit.

According to an aspect of the embodiment, it becomes possible to appropriately provide the information based on the rating obtained by taking the future into account.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a generating unit that generates a rating function for each node of a second-type graph which is generated from a first-type graph in which predetermined elements are treated as nodes and relationships among the elements are treated as links, and which indicates a futuristic state of the first-type graph; and
a providing unit that provides information related to the second-type graph based on the rating function for the each node as generated by the generating unit.

2. The information processing device according to claim 1, wherein the generating unit generates the rating function for the each node based on Dynamic PageRank.

3. The information processing device according to claim 1, wherein the generating unit predicts would-be-generated nodes corresponding to futuristic elements based on Barabasi-Albert model, and generates the second-type graph by adding nodes and developing the first-type graph.

4. The information processing device according to claim 1, wherein the providing unit provides information indicating such nodes, from among first-type nodes included in the second-type graph and the first-type graph, which satisfy a predetermined standard based on the rating functions for the first-type nodes.

5. The information processing device according to claim 1, wherein the providing unit provides information indicating such nodes, from among first-type nodes included in the second-type graph and the first-type graph, which are second-type nodes joined to the first-type nodes and whose rating based on the rating functions for second-type nodes included only in the second-type graph satisfies a predetermined standard.

6. The information processing device according to claim 1, wherein, in the first-type graph, technical literatures are treated as the nodes.

7. An information processing method implemented by a computer, comprising:
generating a rating function for each node of a second-type graph which is generated from a first-type graph in which predetermined elements are treated as nodes and relationships among the elements are treated as links, and which indicates a futuristic state of the first-type graph; and
providing information related to the second-type graph based on the rating function for the each node as generated by the generating unit.

8. A non-transitory computer-readable recording medium having stored therein an information processing program, wherein the information processing program, when executed by a computer, causes the computer to perform:
generating a rating function for each node of a second-type graph which is generated from a first-type graph in which predetermined elements are treated as nodes and relationships among the elements are treated as links, and which indicates a futuristic state of the first-type graph; and
providing information related to the second-type graph based on the rating function for the each node as generated by the generating unit.
